(19) United States
(12) Patent Application Publication
(10) Pub. No.: US 2014/0340023 A1
(43) Pub. Date: Nov. 20, 2014

(54) HYBRID BATTERY BALANCING SYSTEM

(71) Applicant: Ying-Haw SHU, Taipei City (TW)

(72) Inventor: Ying-Haw SHU, Taipei City (TW)

(21) Appl. No.: 13/897,099

(22) Filed: May 17, 2013

(51) Int. Cl. H02J 7/00

(52) U.S. Cl. CPC H02J 7/0018
USPC 320/107

(57) ABSTRACT

A hybrid battery balancing system coupled to a battery pack protection system having a main control processor is provided. The battery balancing system includes a plurality of bypassing equalizers within a cell-voltage and temperature detecting module, the bypassing equalizers read cell voltage and temperature information from the cell-voltage and temperature detecting module, and upload the cell voltage and temperature information to the main control processor, which returns a balance instruction to control a bypass current for facilitating a passive control. The hybrid battery balancing system further includes a plurality of independent battery chargers coupled to the cell-voltage and temperature detecting module, and a battery pack with a plurality of battery cells and connected between the battery charger and the cell-voltage and temperature detecting module in a cascaded fashion. The multiple independent battery chargers are coupled with the bypassing equalizers to enhance the equivalent balancing capacity of bypassing equalizers.

### BACKGROUND OF THE INVENTION

1. Field of the Invention

The instant disclosure relates to a hybrid battery balancing system, and more particularly, to a hybrid battery balancing system incorporating both active balancing and bypass balancing structures for meeting the demands of large-size battery packs requiring effective balancing currents and balancing capacitance in rapid charging.

2. Description of Related Art

In general lithium, manganese, cobalt, and nickel-based batteries (Li—Mn—Co—NiO2), the appearing cell voltages effectively reflect the state of charge (SOC) of the batteries. Even so, the voltage difference among the battery cells arising out of the difference in their characteristics would have negative impact on the rule of battery SOC determination depending on the cell voltage. In FIG. 1, when the lithium, manganese, cobalt, nickel-based batteries are charged or discharged at 0.5 charging and discharging rate, both of which indicate the charging and discharging current divided by the nominal ampere-hour, respectively. Specifically, the battery charged from 85% or 90% to 100% in SOC may take 50% of the overall battery charging time, which is a critical characteristic in the battery balancing, but not desirable when it comes to the rapid battery charging.

FIG. 2 shows the time-varying cell voltage of a conventional lithium iron phosphate (LiFePO4) operating at 0.5 charging and discharging rate. It is shown in FIG. 2 that the charging and discharging curves of such battery are associated with longer “flat” areas, and the rapid rises/falls only take place at the end of the discharging and charging. Any mechanism aiming for balancing the lithium iron phosphate batteries could be challenged since the reading of the cell voltage needs precise calibration, and the difference in battery structure or material purity in the manufacturing process could lead to the variation in the cell voltage. Both of those two issues could attribute to erroneous SOC determination on the cell voltage. Besides, the voltage variation happening in the last 0.3%-0.8% of the battery charging is too large, and the time period for the SOC/battery balancing is too short to achieve the goal of the SOC balancing.

The SOC balancing is generally handled by balancing circuits such as passive/bypassing equalizer and active equalizer. Advantages of the active equalizer include (1) effectively preventing the continuing rise of the cell voltages of the cascaded batteries to extend the charging time of the battery pack, therefore, effectively increasing the available service-capacity range in the rapid charging, (2) in the discharging process transferring the electrical energy from battery cell with the larger SOC to the battery cell with the lesser SOC to effectively enhance discharging capacity of the battery pack when significant difference exists between the battery cells in their SOC, and (3) increasing the potential ampere-hours could be used as the larger balancing current is used for the battery pack having a single cell with a larger SOC in the discharging process. However, the disadvantages of the active equalizer include (1) shortening the service life-cycles of the batteries because of the rapid charging and discharging taking place during the active balancing, especially for the floating charging stage in which the battery is charged at a fixed charging voltage, (2) increased possibility of erroneous reading of cell voltages because of the rapid charging and discharging (since the cell voltage is the result of electrochemical equilibrium, or the cell voltage takes some time to be stable after being disturbed), interfering the balancing decision, and further shortening the service life-cycles of the batteries, (3) undesirable efficiency in balancing the cell with the lower SOC with the balancing current (for example, the equivalent balancing current is less than 250 mA for the lower-SOC battery cell within 12 battery cells in serial connection with the maximum balancing current staying at 5 amperes applied by the active equalizer), and (4) costing too much to get the expected balancing result.

On the other hand, advantages of the passive balancing include (1) by providing a bypassing circuitry for partially charging the battery cell having the largest SOC during the same charging period in order to get the SOC balance of the battery cells (rather than discharging the battery with the largest SOC, which may shorten the service life-cycle of the same), (2) simplifying the design of the balancing circuitry without fast discharging then charging between battery cells, (3) less reading interference of the cell voltage due to minimized occurrence of the electric-charge accumulation on the electric polar of battery cell, (4) the SOC discrepancy between the battery modules, which is handled by different balancing controllers, becoming under control, which is suitable for large-size battery pack, (5) eliminating the continuous but useless charging and discharging of the battery pack which is in connection with the reliable power supply for such as uninterruptible power system, UPS), thus maintaining the service life-cycle of the battery pack, and (6) being able to heat up the whole battery pack making the passive balancing widely adopted in solar lamp systems in the freezing areas.

Disadvantages of the passive balancing include: (1) more power consumption because of the presence of the charging bypass circuit, and lowering the charging efficiency and generating additional heat, which may cast additional challenge to the maintaining of the service life-cycle of battery pack, suggest the balancing current restriction in the passive balancing, (2) limitation on the power consumption associated with the bypassing current in the bypass circuit, (3) limitation on self leakage of the battery (otherwise, the balancing current for the periodically used battery pack may not be realized after one or multiple charging/discharging periods) and necessity of pre or post-balancing to enhance the balancing performance in one single charging period, though the post-balancing may not be suitable for the lithium iron phosphate battery cells because of their cell voltages v. SOC characteristics, and (4) inferior charging efficiency.

Additionally, another equalizer circuit having multiple battery chargers isolated from each other in their input/output voltages, each of which is adapted to independently charge its corresponding battery cell, has been developed. Since the charging process for each battery cell is controlled by the corresponding battery charger, it is possible that each battery cell is fully charged. As such, the advantages of this equalizer include avoiding the use of complicated control system, accommodating more significant SOC discrepancy between the battery cells, and suffering no problem associated with the transfer of the electrical energy between the battery cells. Since the battery chargers here have their input terminals connected to the same power supply in parallel and their output terminals are serially connected to the battery cells, the either AC or DC power is delivered to the battery cells. Therefore, the disadvantages of this equalizer may include: (1) requiring additional wiring within the battery pack, complicating the design and increasing the risk of the operation of the battery pack, (2) external connecting points of the battery wires being laid bare, sensitive to EMI/ESD impact and thus affecting the EMC tolerance level of the whole battery pack, (3) higher cost for this type with high-current and low-voltage equalizer, and lowered conversion efficiency, both of which are unfavorable for the promotion of such equalizer, and (4) as incorporated into large-size battery systems increasing the difficulty in terms of wiring.

Therefore, the equalizer composed of high SOC adjustability in the active equalizers or the equalizers having multiple independent battery chargers and charging-current adjustment without energy transfer between the battery cells in the bypassing equalizer could effectively eliminate the discrepancy in the battery SOC, satisfy the need of the rapid charging, and will be the best solution for battery balance.

### SUMMARY OF THE INSTANT DISCLOSURE

A hybrid battery balancing system coupled to a battery pack protection system having a main control processor is provided. The battery balancing system includes a plurality of bypassing equalizers within a cell-voltage and temperature detecting module, the bypassing equalizers read cell voltage and temperature information from the cell-voltage and temperature detecting module, and upload the cell voltage and temperature information to the main control processor, which returns a balance instruction to control a bypass current for facilitating a passive control. The hybrid battery balancing system further includes a plurality of battery chargers coupled to the cell-voltage and temperature detecting module, and a battery pack with a plurality of battery cells and connected between the battery charger and the cell-voltage and temperature detecting module in a cascaded fashion. The battery cell is connected to the battery charger and the bypassing equalizer.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows charging/discharging curves for a lithium, manganese, cobalt, and nickel-based battery;

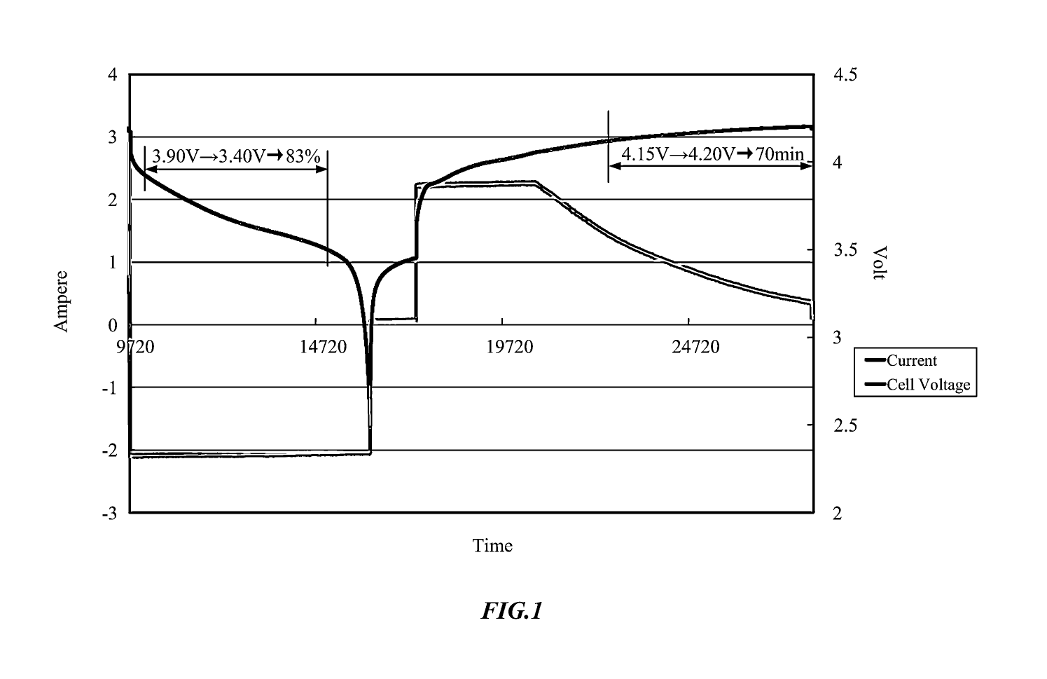

FIG. 2 shows charging/discharging curves for a conventional lithium iron phosphate battery;

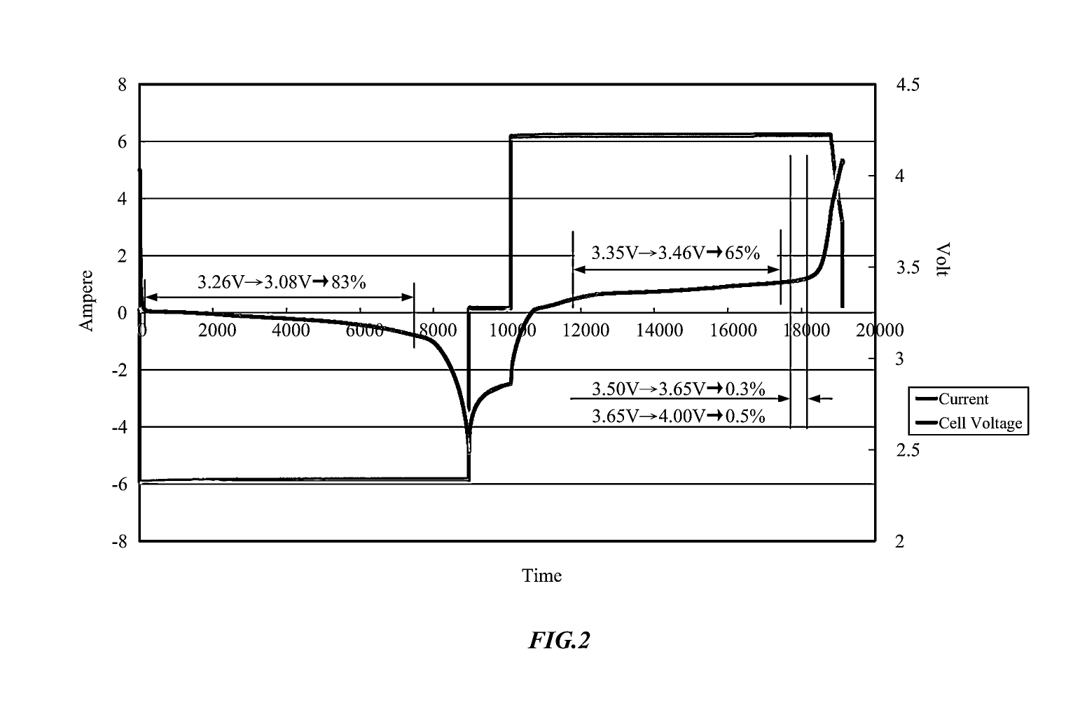

FIG. 3 shows a schematic diagram of a hybrid battery balancing system according to one embodiment of the instant disclosure;

FIG. 4 shows the variation relationship between the charging current and the charging voltage of the battery charger when one of the preferred adjusting approaches is adopted;

FIG. 5 shows a hybrid battery balancing system according to one embodiment of the instant disclosure;

FIG. 6 shows an experiment result for the system in FIG. 5 according to one embodiment of the instant disclosure;

FIG. 7 shows another experiment result of the system in FIG. 5 according to one embodiment of the instant disclosure;

FIG. 8 is another hybrid battery balancing system according to one embodiment of the instant disclosure;

FIG. 9 is another hybrid battery balancing system according to one embodiment of the instant disclosure; and

FIG. 10 shows the experiment result of the embodiment in FIG. 9.

### DETAILED DESCRIPTION OF THE EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

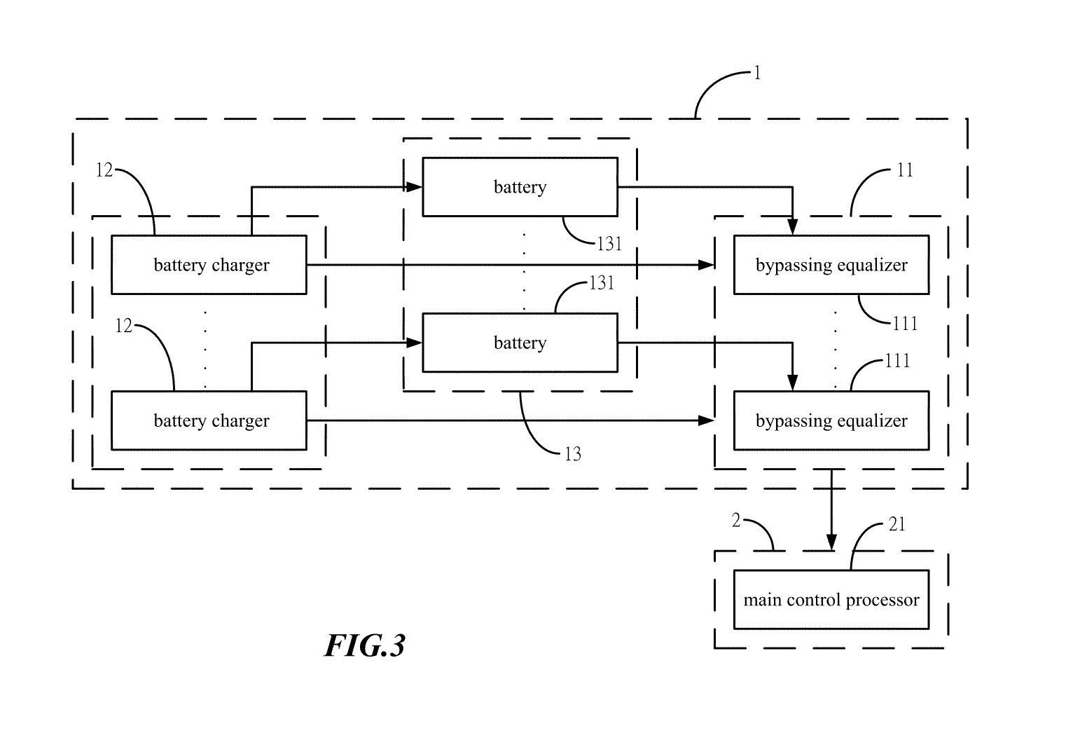

Please refer to FIG. 3 showing a schematic diagram of a hybrid battery balancing system 1 according to one embodiment of the instant disclosure. The hybrid battery balancing system 1 may be coupled to a battery pack protection system 2 having a main control processor 21. The hybrid battery balancing system 1 may further include multiple bypassing equalizers 111, multiple battery chargers 12 and a battery pack 13. In one implementation, the bypassing equalizer 111 may be built within a cell-voltage and temperature detecting module 11, while multiple batteries 131 of the battery pack 13 connected in a cascaded manner may be connected between the battery charger 12 and the bypassing equalizer 111.

The bypassing equalizer 111 may be adapted to read cell voltage and temperature information of the cell-voltage and temperature detecting module 11 before uploading the same (i.e., the cell voltage and temperature information) to the main control processor 21. The main control processor 21 may return a balance instruction to control a bypass current of the bypassing equalizer 111. Plus, since the output current of the battery charger 12 may be adjustable as well as the output voltage thereof, each of the batteries 131 may be charged by its corresponding charging current based on its required voltage and state of charge (SOC).

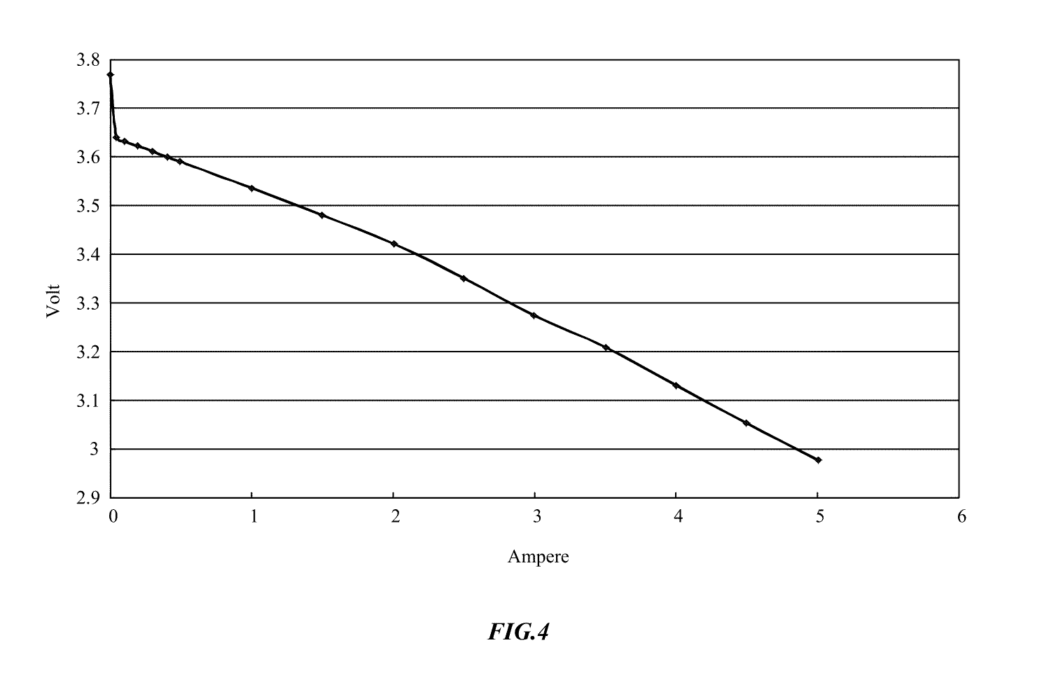

Differences between the battery pack in the instant disclosure and the conventional one may include the charging current comes from the independent battery charger 12 as well as the output current of the external main battery charger, and the output current of the independent battery charger will decrease over the course of the output of the output voltage. As shown in FIG. 4 showing the variation relationship between the charging current and the charging voltage of the battery charger, the battery with the lesser SOC may be associated with the lesser cell voltage when the battery charging process advances at which point the charging current provided by the independent battery charger may become too large in terms of battery charging for that particular battery. Thus, the output current of the independent battery charger is adjustable on basis of the cell voltage and that helps the bypassing equalizer improve its performance in effectively adjusting the charging current without generating excessive heat.

FIG. 4 illustrates the variation relationship between the charging current and the charging voltage of the battery charger when one of the preferred adjusting approaches is adopted. The charging current may be supplied by the battery charger 12 when the cell voltage exceeds 3.0 volts. The charging current may be reduced when the cell voltage continues to climb. For example, the charging current may be lowered to less than 100 mA when the cell voltage is at 3.65 volts. Also, it could be inferred from FIG. 4 that when the cell voltage is at the range from 3.50 volts and 3.65 volts, which is critical to the battery charging of a lithium iron phosphate battery, the swing of the output current of the battery charger 12 could be as large as 1 ampere. With this arrangement, in the advanced stage of the battery charging for the lithium iron phosphate battery the cell voltage of the lesser SOC may be provided with the larger electrical energy, increasing the cell voltage of the same battery 131 more promptly. Since the output voltage of the battery charger may remain steady throughout the course of the battery charging of all batteries 131, when the battery with the lesser SOC enjoys the larger charging current from the battery charger 12 the battery with the larger SOC may receive the lesser charging current from the battery charger, restraining the climb of the cell voltage of the battery larger in SOC and effectively improving the efficiency of the battery charging.

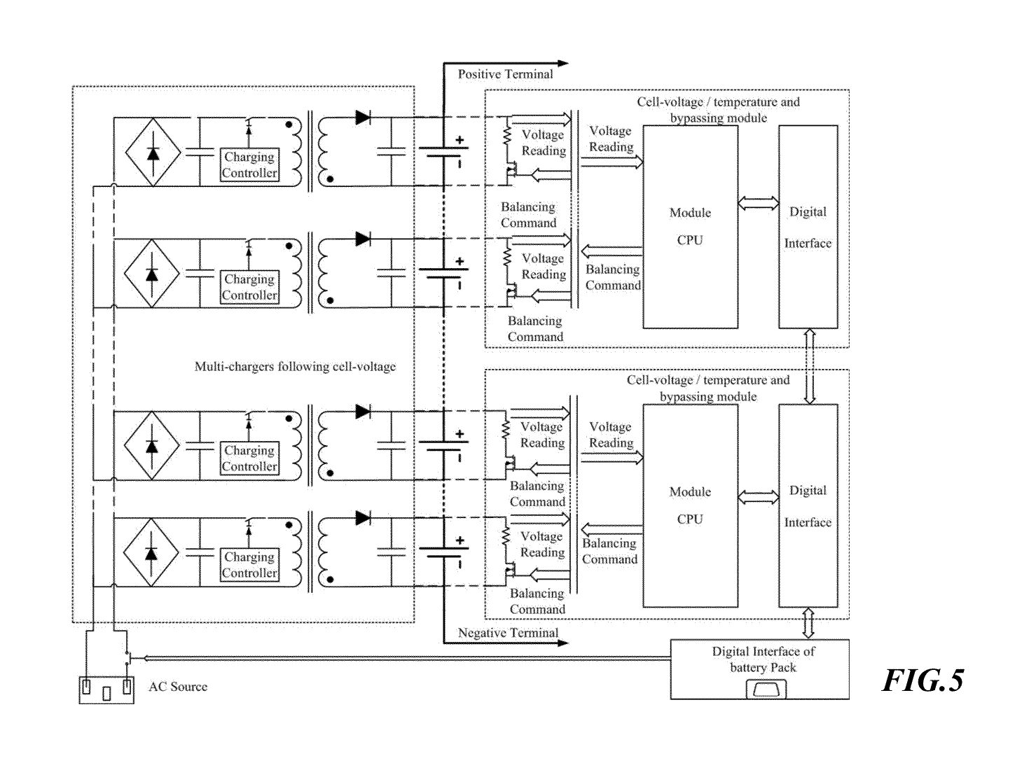

FIG. 5 shows a hybrid battery balancing system according to one embodiment of the instant disclosure. The embodiment in FIG. 5 is directed to a hybrid structure consisted of multiple battery chargers adapted to adjust their output currents based on their output voltages. As shown in FIG. 5, multiple standard modular bypassing equalizers are on the right side and they are for reading the cell voltage and the temperature in terms of analog signal, before converting the retrieved analog signals to their corresponding digital counterparts and uploading the digital signals to the main control processor of a battery pack protection system. The bypassing equalizer meanwhile may determine a bypassing behavior associated with the operation of the passive balancing based on historical data and balance instructions returned from the main control processor of the battery pack protection system.

On the left side of the structure shown in FIG. 5 are multiple battery chargers. It is worth noting that the multiple battery chargers in FIG. 5 may be similar to the battery chargers in FIG. 4 in their characteristics. In other words, the output current of the battery charger in FIG. 5 may be adjusted based on the output voltage of the battery charger. And the extent of the output current being adjusted may be according to the types of batteries, the size of the battery pack, the maximum current supply of the battery charger, and the balancing algorithm dictating the operation of the main control processor in the battery pack protection system. In this embodiment, the bypassing equalizer and the cell-voltage and temperature detecting module may not involve the operation of the multiple battery chargers. Rather, the main control processor may determine when the multiple battery chargers is activated, with the controllable multiple battery chargers powered by external alternating current power sources such as an AC power source in FIG. 5.

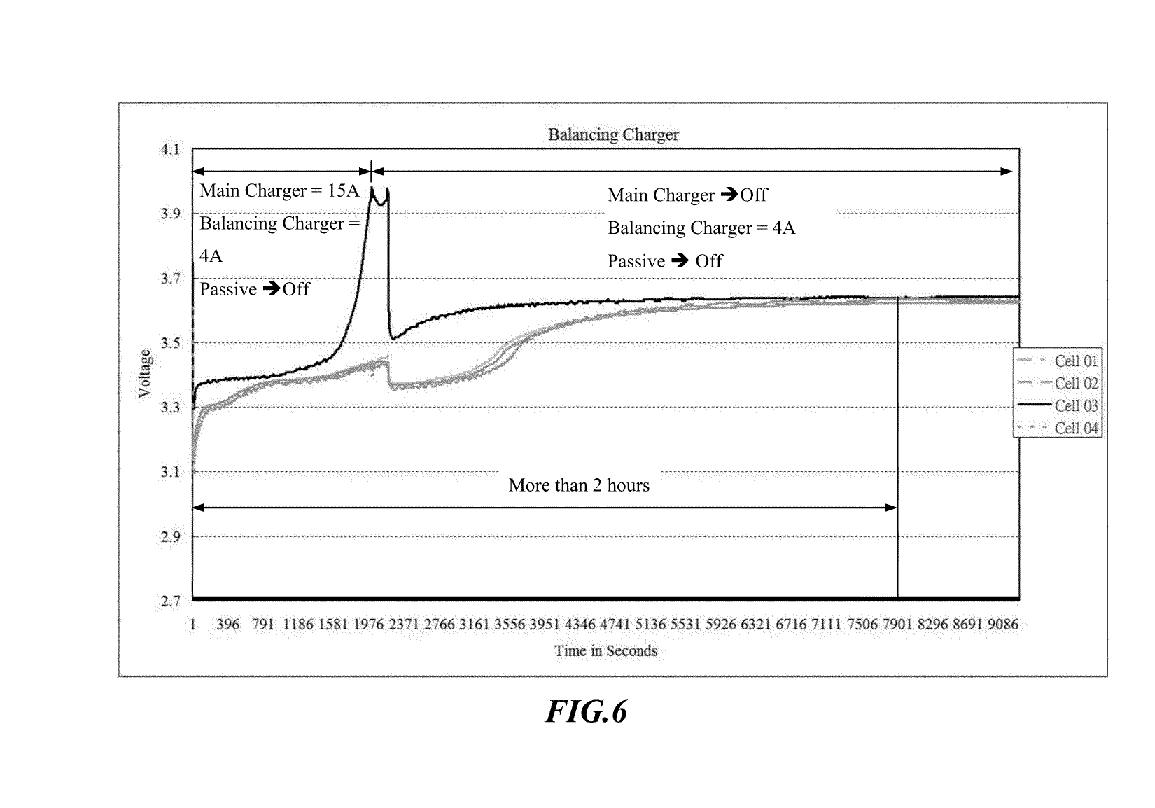

FIG. 6 shows an experiment result for the system in FIG. 5 according to one embodiment of the instant disclosure. The battery pack employs 16 batteries connected in a cascaded fashion with each of the batteries 28.8 Ah (2% tolerance) in SOC. Additionally, the multiple battery chargers used for this experiment may adjust their output currents on basis of their output voltages, similar to the battery charger utilized in FIG. 4, and may be adapted to charge the batteries at the same pace. The maximum output voltage of the battery charger in the embodiment of FIG. 6 is 3.62 volts at 100 mA while the maximum output current is 4.2 amperes at 3.2-3.5 volts. Meanwhile, the passive balance current is 120 mA and the specification of the external power source/main charger is 15 amperes at 30-58 volts. For the experiment purpose, 16 batteries are charged to 3.63 volts and the output current of the battery charger is less than 200 mA. Thereafter, the 16 batteries are discharged by 20 ampere-hours before having the third battery in the 16-battery battery pack charged by 5 ampere-hours (or 15 ampere-20 minutes). As shown in FIG. 6 where the status of the first battery to the fourth battery is illustrated (cells 1-4), SOC of the third battery, which is further charged by 5 ampere-hours, is at 86% as 35 minutes from start, when other batteries, which are not charged after being discharged, are at 68% in SOC. Despite the battery charger for the third battery may be aware of the rising of the cell voltage of the third battery and lower the corresponding charging current, the output voltage of the external battery charger may stay in the range from 54.2 to 54.7 volts and the output current of the same external battery charger may remain at 15 amperes. Further, because of the high impedance of the lithium iron battery at its last stage of the battery charging, the rapid rise of the cell voltage of the third battery may trigger the bypassing equalizer and the cell-voltage and temperature detecting module, and then cut off the external power source/main charger. Therefore, the multiple battery chargers, which may be labeled as the equalization chargers, need to take over the battery charging of the last battery cell in the battery pack. Accordingly, the battery charging for the entire battery pack may last for more than two hours.

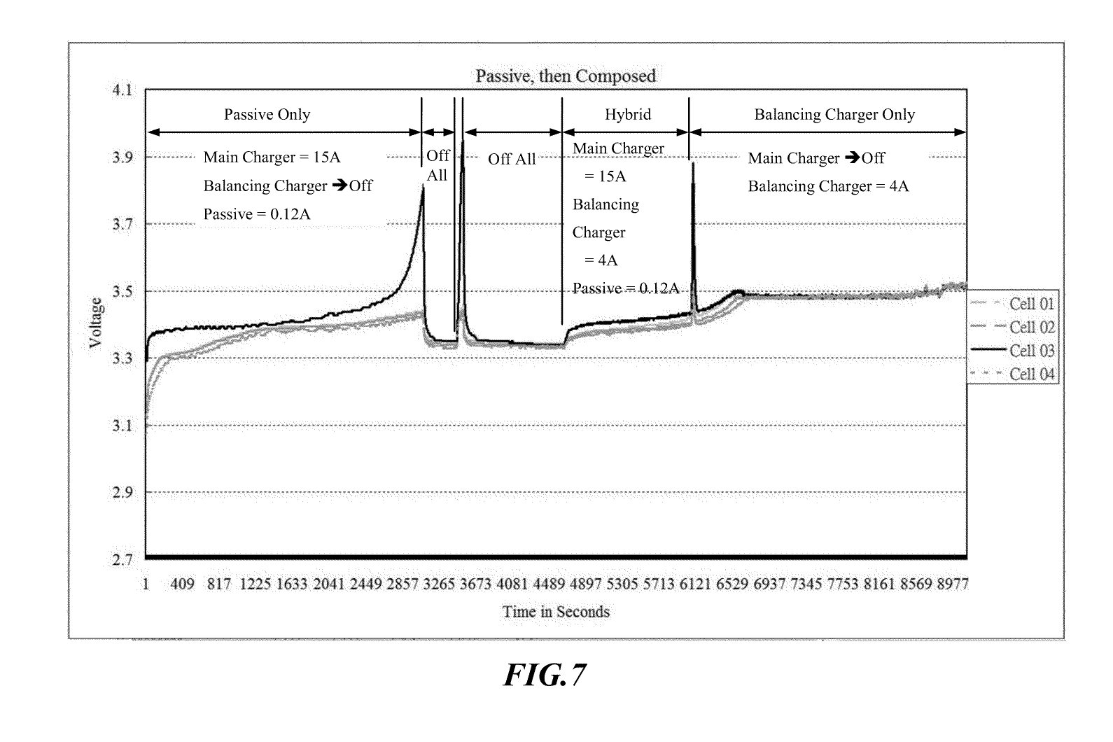

FIG. 7 shows another experiment result of the system in FIG. 5 according to one embodiment of the instant disclosure. One difference between the experiment result in FIG. 7 and the one in FIG. 6 is the use of the traditional bypassing balancing approach in FIG. 7. It is worth noting that the bypassing balancing and the passive balancing may be interchangeable throughout the instant disclosure. As previously mentioned, SOC of the third battery is larger than other 15 batteries by 5 ampere-hours and such difference in SOC may not be compensated by one single charging, which generally wraps up within 2 hours. However, the bypassing equalizer before the battery charging officially starts may detect the cell voltage of the third battery is larger than others' cell voltage, and such detection may cause the passive balancing to take place. Thus, the rapid rise in the cell voltage of the third battery may happen after the charging of 11.9 ampere-hours, at which point SOC of the third battery may reach 90%. Even the hybrid charging is activated when the third battery cell is reaching 90% in SOC, the rise in the total voltage due to the charging of the third battery cell may not stop the large charging current from being received from the external power source/main charger. Therefore, the multiple battery charger adapted for equally charging may be turned to for finishing the battery charging of other battery cells in the same battery pack.

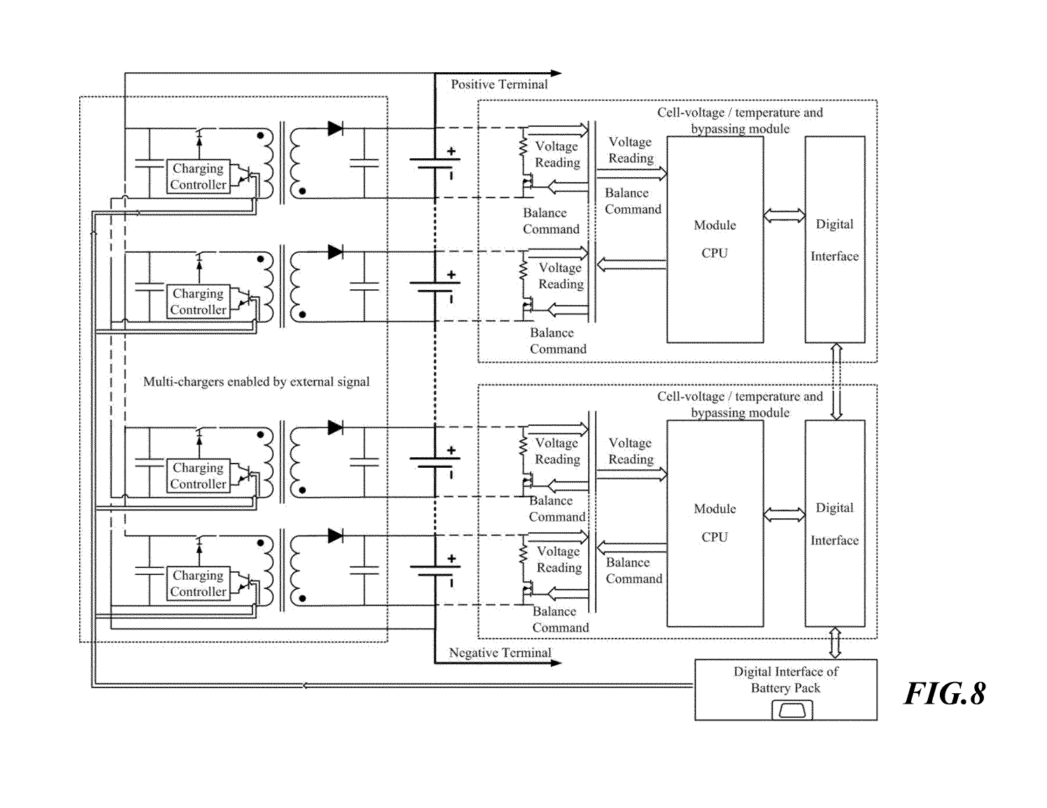

FIG. 8 shows another system according to one embodiment of the instant disclosure. The embodiment in FIG. 8 illustrates a hybrid battery balancing scheme including multiple battery chargers. Unlike the embodiment in FIG. 5, a direct current (DC) power comes from an external charger outside the battery pack, and no external AC power source is used for simplifying the design of the external wiring of the battery pack. Similarly, the power of the multiple battery chargers are not supplied by the battery cells, eliminating the possibility of the battery discharging because of the SOC difference among the battery cells, extending the service life-cycles of the batteries.

Since the DC power for the multiple battery chargers may come from the external main charger, the charging current for the battery cell with the larger SOC may be reduced, therefore effectively preventing the cell voltage of such battery cell from increasing. The main control processor may be configured to control/coordinate the charging of the multiple battery chargers as well.

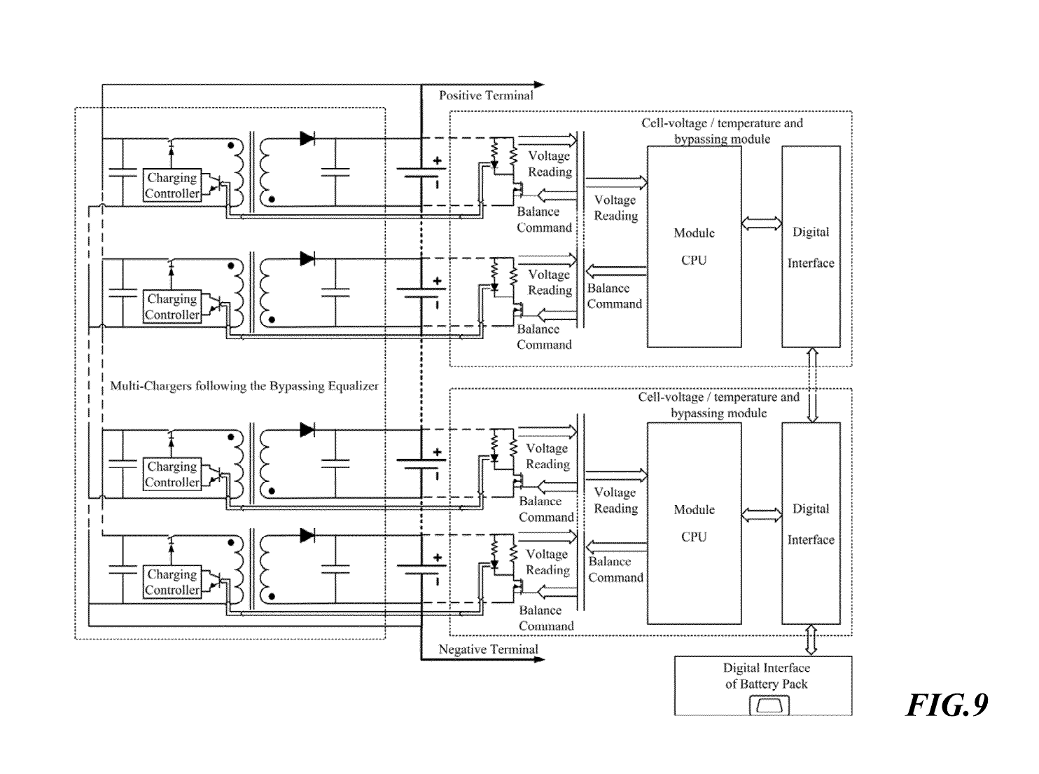

FIG. 9 illustrates another system according to one embodiment of the instant disclosure. The system in FIG. 9 may include multiple battery chargers controlled by a photo coupler. The system may also include a bypassing equalizer for controlling the charging of the battery chargers, simplifying the balancing mechanism provided by the main control processor and effectively resulting in a dynamic balancing charger. The multiple battery chargers used in this embodiment could be constant current charger to continuous voltage (CC-CV) chargers. Thus, when the bypassing equalizer and the cell-voltage and temperature detecting module activates the bypassing current, the operation of the battery charger may be suspended, significantly increasing the amount of the current at the disposal of the bypassing equalizer and the cell-voltage and temperature detecting module. Moreover, the battery with the lesser SOC may be charged by the larger equivalent charging current compared to the battery with the larger SOC, which may be charged by the lesser equivalent charging current. Consequently, the battery with the lesser SOC could be supplied with the electrical energy more promptly.

One advantage of this embodiment is the modularized bypassing equalizer, which may be fully integrated with the multiple battery chargers. In the hybrid system with the modularized bypassing equalizer, excessive heat associated with discrete bypassing equalizer could be effectively avoided, and the difference in SOC between the battery modules could be accommodated and adjusted by the bypassing equalizer. It is worth noting that the battery chargers in this embodiment are powered by the external power source.

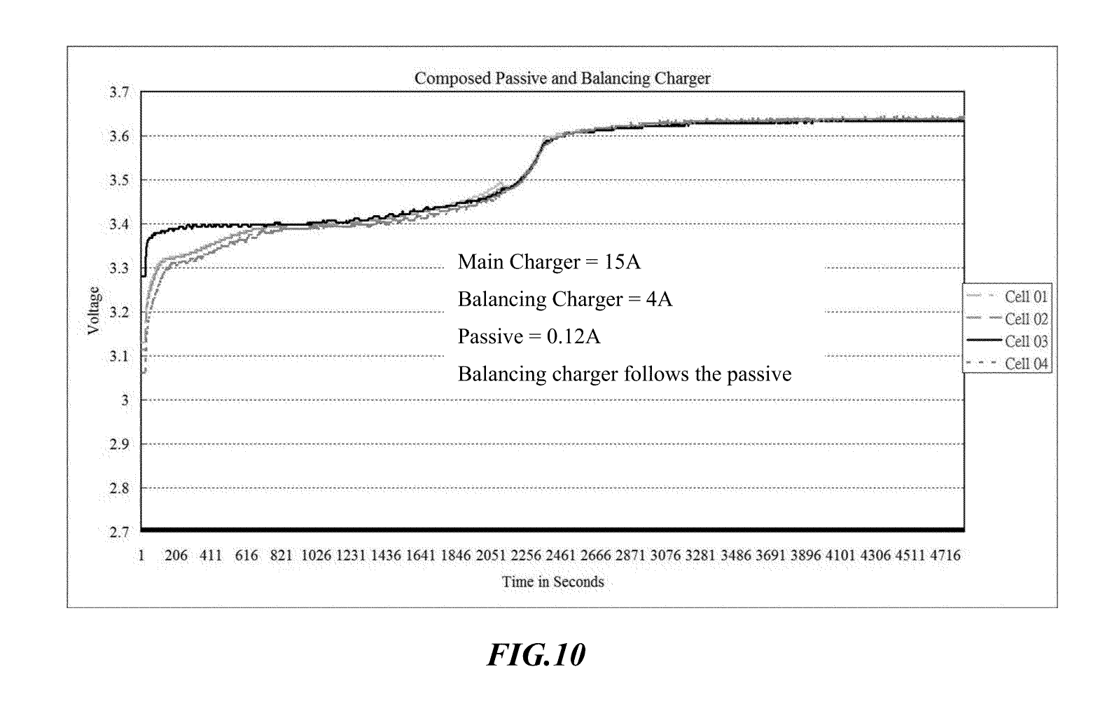

The embodiment in FIG. 8 also incorporates 16 battery cells connected in the cascaded manner, with SOC of each of the battery cells around 28.8 Ah (±2%). And the multiple battery chargers used in the same system embodiment may be also capable of adjusting their output currents based on their output voltages, and the battery chargers used in this embodiment are similar to the battery chargers employed in the embodiment of FIG. 4. That said, the maximum output voltage of the battery charger is 3.62 Volts at 100 mA and the maximum output current is 4.2 amperes at the range between 3.2-3.5 volts and the passive balance current is 120 mA. The specification of the external main charger is 15 amperes at the range of 30-58 volts. Similarly, the 16 battery cells may be charged by the battery charger to 3.62 volts and the output current thereof may be caused to be less than 200 mA. Before the experiment for the system in this embodiment is conducted, all of the 16 battery cells may be further discharged by 20 ampere-hours before the third battery cell is charged by 5 ampere-hours or 15 amperes for 20 minutes. It could be seen from FIG. 10 showing the experiment result of the embodiment in FIG. 9. Since the hybrid battery balancing circuit somewhat curbs the charging of the third battery cell while imposing no such limitation on other 15 battery cells, SOC of the battery cells other than the third one may be effectively recovered. Also, because the charging current required for the charging of the third battery cell is less than other charging currents for the remaining 15 batteries by 4.2 amperes the increase/rise in the cell voltage of the third battery cell may not be as much as those of other battery cells. Accordingly, the balance of the cell voltages of the battery cells in the same battery pack may be reached in about 38 minutes, when the charging of the whole battery pack may be accomplished in about 58 minutes.

The hybrid battery balancing system of the instant disclosure compared with other conventional arts possesses at least the following advantages: (1) employing multiple independent chargers capable of adjusting their output currents according to their output voltages, with such adjustable output currents supplied to the battery cells depending on their cell voltages and SOC, which enhances the adjustability of the charging currents required for the passive balancing to offset the limitation on the balancing currents associated with the passive balancing; (2) lesser cost associated with the preparation of the battery chargers compared with that in the battery chargers of the active balancing; and (3) eliminating the need of extracting the electrical energy from the battery cells larger in SOC or delivering the electrical energy for the balancing to the battery cells requiring no such delivery, which has been identified as one drawback in the conventional active balancing, and therefore further eliminating the rapid charging/discharging that could shorten the service life-cycles of the battery cells.

The descriptions illustrated supra set forth simply the embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A hybrid battery balancing system coupled to a battery pack protection system having a main control processor, the battery balancing system comprising:
a plurality of bypassing equalizers within a cell-voltage and temperature detecting module, the bypassing equalizers reading cell voltage and temperature information from the cell-voltage and temperature detecting module, and uploading the cell voltage and temperature information to the main control processor, which returns a balance instruction to control a bypass current for facilitating a passive control;
a plurality of battery chargers coupled to the cell-voltage and temperature detecting module; and
a battery pack with a plurality of battery cells and connected between the battery charger and the cell-voltage and temperature detecting module in a cascaded fashion, wherein the battery cell is connected to the battery charger and the bypassing equalizer.

2. The hybrid battery balancing system according to claim 1, wherein the hybrid battery balancing system draws no electrical energy from the battery cells and the multiple battery chargers are adapted to provide currents required by the hybrid battery balancing system for balancing a state of charge (SOC) of the battery cells.

3. The hybrid battery balancing system according to claim 1, wherein the battery chargers are constructed from multiple independent chargers and powered by an external main charger or an AC (alternating power) source, and are instructed to operate by the main control processor.

4. The hybrid battery balancing system according to claim 1, wherein the battery chargers are constructed from multiple independent chargers and powered by an external main charger or an AC (alternating power) source, and are instructed to operate by the bypassing equalizer of the cell-voltage and temperature detecting module.
